(19) United States
(12) Patent Application Publication
(10) Pub. No.: US 2012/0075163 A1
(43) Pub. Date: Mar. 29, 2012

(54) ANTENNA ASSEMBLY PROVIDING MULTIDIRECTIONAL ELLIPTICAL POLARIZATION

(75) Inventor: Jack Nilsson, Medina, OH (US)

(73) Assignee: MP Antenna, Ltd.

(21) Appl. No.: 13/239,503

(22) Filed: Sep. 22, 2011

Related U.S. Application Data
(60) Provisional application No. 61/386,115, filed on Sep. 24, 2010.

(51) Int. Cl. H01Q 21/24

(52) U.S. Cl. 343/893

(57) ABSTRACT

An antenna assembly having a characteristic wavelength is provided including a continuous conductive assembly formed from a plurality of conductive segments. Each of the plurality of conductive segments is either linear or curvilinear, and the continuous conductive assembly is configured to be substantially responsive to elliptically polarized, radio frequency signals of the characteristic wavelength within each of three mutually orthogonal planes.

### RELATED APPLICATION

This application claims priority from U.S. Provisional Patent Application Ser. No. 61/386,115, filed Sep. 24, 2010, the subject matter of which is incorporated herein by reference.

### TECHNICAL FIELD

Certain embodiments of the present invention relate to antennas for wireless communications. More particularly, certain embodiments of the present invention relate to an apparatus and method providing an antenna assembly of reduced size exhibiting polarization and spatial diversity for use in point-to-point and point-to-multipoint communication applications for the Internet, land, maritime, aviation, and space.

### BACKGROUND OF THE INVENTION

Wireless communications have always struggled with limitations of audio, video, and data transport and internet connectivity in both obstructed and line-of-sight (LOS) deployments. A focus on antenna gain and transceiver processing solutions has proven to have significant limitations. While lower frequency radio waves benefit from low elevation propagation and higher frequencies do inherently benefit from reflection and penetration characteristics, due to topographical changes (hills & valleys) and obstructions, both natural and man-made, and the accompanying reflections, diffractions, refractions and scattering, the maximum signal received may well be off-axis, that is, received via a path that is not line-of-sight. Further, destructive interference of multi-path signals can result in nulls and locations of diminished signal. Some antennas may benefit from having gain at one elevation angle to ‘capture’ signals of some pathways, while other antennas have greater gain at another elevation angle, each type being insufficient where the other does well. Radio waves can also experience altered polarizations as they propagate, reflect, refract, diffract, and scatter. A preferred polarization path may exist, but insufficient capture of the signal can result if this preferred path is not utilized.

### BRIEF SUMMARY OF THE INVENTION

In accordance with an aspect of the invention, an antenna assembly having a characteristic wavelength is provided including a continuous conductive assembly formed from a plurality of conductive segments. Each of the plurality of conductive segments is either linear or curvilinear, and the continuous conductive assembly is configured to be substantially responsive to elliptically polarized, radio frequency signals of the characteristic wavelength within each of three mutually orthogonal planes. It will be appreciated that the ability of the antenna assembly to be responsive to multiple polarizations can greatly improve the performance of the antenna, extending its useful range. For example, polarization diversity at the receive end increases the likelihood of capturing usable signal after the signal properties have been altered by obstructed pathways. Polarization diversity at the transmit end increases likelihood of a useable obstructed environment pathway (e.g., through nooks and crannies) to the receiver.

In accordance with another aspect of the present invention, a passive antenna module is configured to enhance the performance of an associated antenna system. The passive antenna module is composed of a plurality of conductive elements, including a first proper subset configured to provide a first dipole, having a length substantially equal to one-half of a characteristic wavelength associated with the antenna system and aligned along a first axis. A second proper subset of the plurality of conductive elements is configured to provide a second dipole having a length substantially equal to one-half of the characteristic wavelength and aligned along a second axis. A third proper subset of the plurality of conductive elements is configured to provide a third dipole having a length substantially equal to one-half of the characteristic wavelength and aligned along a third axis. The first, second, and third axes are mutually orthogonal. The passive antenna module further includes a base conductive segment configured to couple with the antenna system, with each of the plurality of conductive elements being operatively connected to the base conductive segment.

In accordance with yet another aspect of the present invention, a communications system configured to provide polarization diversity is provided. The communications system includes means for receiving elliptically polarized, radio frequency signals within each of three mutually orthogonal planes, with the means for receiving comprising a continuous, conductive member. The system further includes a transceiver system electrically coupled to the means for receiving and configured to receive a radio frequency signal from the means for receiving and process the radio frequency signal to recover information from the radio frequency signal.

### BRIEF DESCRIPTION OF THE DRAWINGS

The foregoing and other features of the present invention will become apparent to those skilled in the art to which the present invention relates upon reading the following description with reference to the accompanying drawings, in which;

FIG. 1 illustrates a communications system comprising an antenna module configured to provide polarization diversity within each of three orthogonal planes in accordance with an aspect of the present invention;

FIG. 2A illustrates a first exemplary implementation of an antenna module in accordance with an aspect of the present invention;

FIG. 2B illustrates the antenna module coupled to a router;

FIG. 2C illustrates the antenna module coupled to a laptop;

FIG. 2D illustrates the first exemplary implementation of the antenna module along a first axis;

FIG. 2E illustrates the first exemplary implementation of the antenna module along a second axis;

FIG. 2F illustrates the first exemplary implementation of the antenna module along a third axis;

FIG. 3A illustrates a second exemplary implementation of an antenna module in accordance with an aspect of the present invention;

FIG. 3B illustrates the second exemplary implementation of the antenna module along a first axis;

FIG. 3C illustrates the second exemplary implementation of the antenna module along a second axis;

FIG. 3D illustrates the second exemplary implementation of the antenna module along a third axis;

FIG. 4A illustrates a third exemplary implementation of an antenna module in accordance with an aspect of the present invention;

FIG. 4B provides an alternative view of the third exemplary implementation of the antenna module view along an axis defined by the linear base;

FIG. 5 illustrates a fourth exemplary implementation of an antenna module in accordance with an aspect of the present invention; and

FIG. 6 illustrates a fifth exemplary implementation of an antenna module in accordance with an aspect of the present invention.

### DETAILED DESCRIPTION OF THE INVENTION

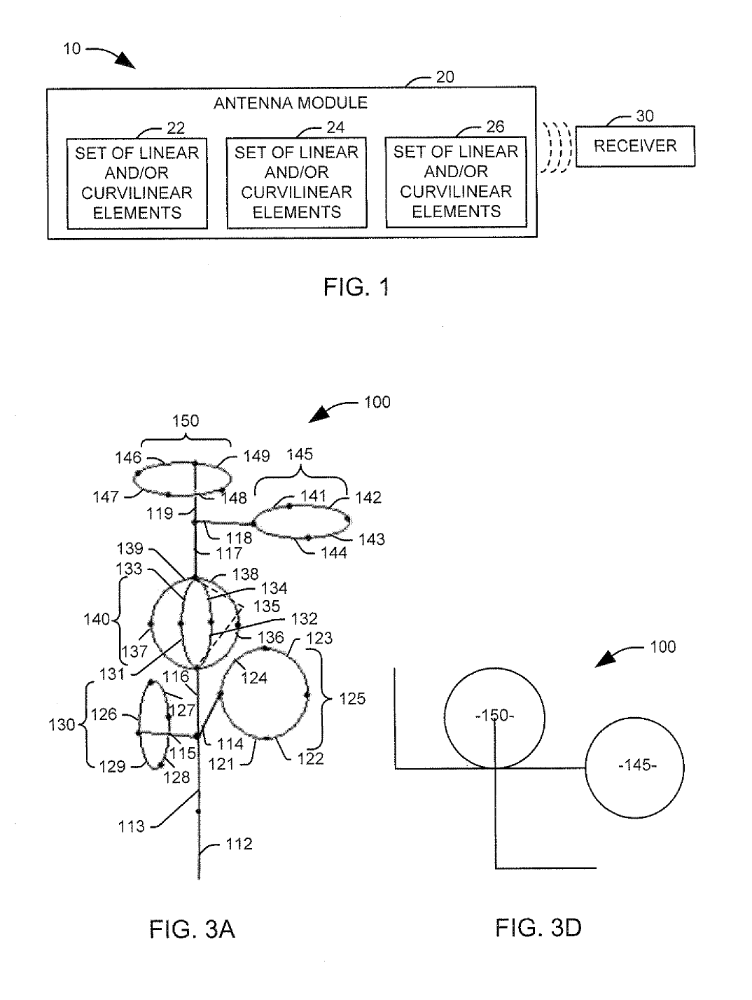

FIG. 1 illustrates a communications system 10 comprising an antenna module 20 configured to provide polarization diversity within each of three orthogonal planes in accordance with an aspect of the present invention. The antenna module 20 comprises a continuous, conductive structure formed as a plurality of linear or curvilinear elements. Each of the plurality of linear or curvilinear elements is physically connected to at least one other element from the plurality of linear or curvilinear element and, in accordance with an aspect of the present invention, the antenna module 20 is configured to provide substantial elliptically polarized response within each of three mutually orthogonal planes. It will be appreciated that by a “substantially elliptically polarized response,” it is meant that the polarization loss factor of the antenna for a circularly polarized signal of the appropriate handedness is trivial (e.g., considerably less than the three decibel polarization loss factor expected for a linearly polarized antenna receiving such a signal.) To the extent that the antenna module is set up as a passive redirect to a main antenna, the elliptical polarization of the antenna provides that a signal orthogonal to the main polarization along any of three orthogonal axes will provide a polarization loss of significantly less than the twenty decibel loss that would be expected. Further, the term “radio frequency,” is intended to encompass frequencies within the microwave and traditional radio bands, specifically frequencies between 3 kHz and 3 THz. While the illustrated antenna assembly 10 is capable of some wideband performance, it will be appreciated that the antenna assembly 10 is tuned to a characteristic frequency, η, representing a frequency band to which the antenna is maximally receptive. Accordingly, the antenna assembly also has a characteristic wavelength, λ,equal to c/η, where c represents the speed of light, equal to approximately 300,000,000 m/s.

The antenna module 20 comprises a first proper subset 22 of the plurality of linear or curvilinear elements that is configured to provide elliptical polarization in a first plane normal to a first of the three axes. It will be appreciated that by a proper subset of the plurality of elements, it is meant that the subset does not include every element of the original set. For example, the first proper subset 22 can include linear and curvilinear elements arranged to approximate a first half-wave dipole aligned substantially perpendicularly to the first axis and approximate a second half-wave dipole aligned substantially perpendicular to each of the first axis and the first half-wave dipole. The first and second half-wave dipoles can be positioned such that output of the second half-wave dipole lags the output of the first half-wave dipole by approximately a quarter of the characteristic wavelength in space.

The antenna module 20 further comprises a second proper subset 24 of the plurality of linear or curvilinear elements that is configured to provide circular polarization in a second plane normal to a second of the three axes. In a manner similar to the first proper subset 22, the linear and curvilinear elements comprising the second proper set 24 are arranged to approximate a third half-wave dipole aligned substantially perpendicularly to the second axis and a fourth half-wave dipole aligned substantially perpendicular to each of the second axis and the third half-wave dipole, positioned such that output of the second half-wave dipole lags the output of the first half-wave dipole by approximately a quarter of the characteristic wavelength in space.

A third proper subset 26 of the plurality of linear or curvilinear elements provides elliptical polarization in a third plane normal to a third of the three axes. For example, its constituent elements arranged to approximate a fifth half-wave dipole aligned substantially perpendicularly to the third axis and a sixth half-wave dipole aligned substantially perpendicular to each of the third axis and the sixth half-wave dipole and positioned such that output of the second half-wave dipole lags the output of the first half-wave dipole by approximately a quarter of the characteristic wavelength in space. It will be appreciated that the first proper subset 22, the second proper subset 24, and the third proper subset 26 of linear and curvilinear elements are generally non-exclusive, such that a given linear or curvilinear element can belong to more than one subset.

The communications system 10 can further comprise a transceiver module 30 configured to transmit signals through the antenna module and receive process the radio frequency signals from the antenna module to recover information from the radio frequency signals. To this end, the transceiver module 30 is electrically coupled to the antenna module 20, such that signals received at the antenna module ca n be processed at the transceiver module. In one implementation, the antenna module 20 is directly feed by the transceiver module 20 and is thus conductively connected to the module. In an alternative implementation, the antenna module 20 can operate as a passive booster for the transceiver system 30, and the antenna module 20 and the transceiver module 30 can be electromagnetically coupled. In this implementation, the transceiver module 30 can include an associated antenna (not shown) and antenna module 20 can include a conductive segment at its base that is configured to inductively and capacitively couple with the associated antenna of the transceiver module. Accordingly, the beneficial properties of the antenna module 20, particularly elliptical polarization within three mutually orthogonal planes, can be provided to an existing transceiver component, such as an internal antenna within a laptop computer or other portable device.

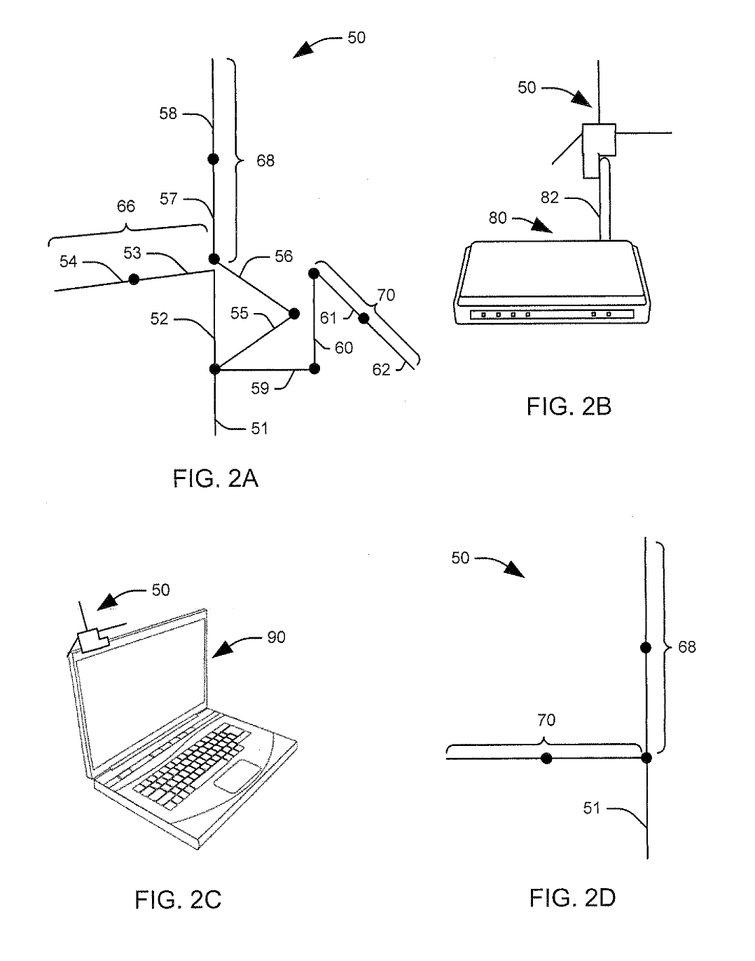

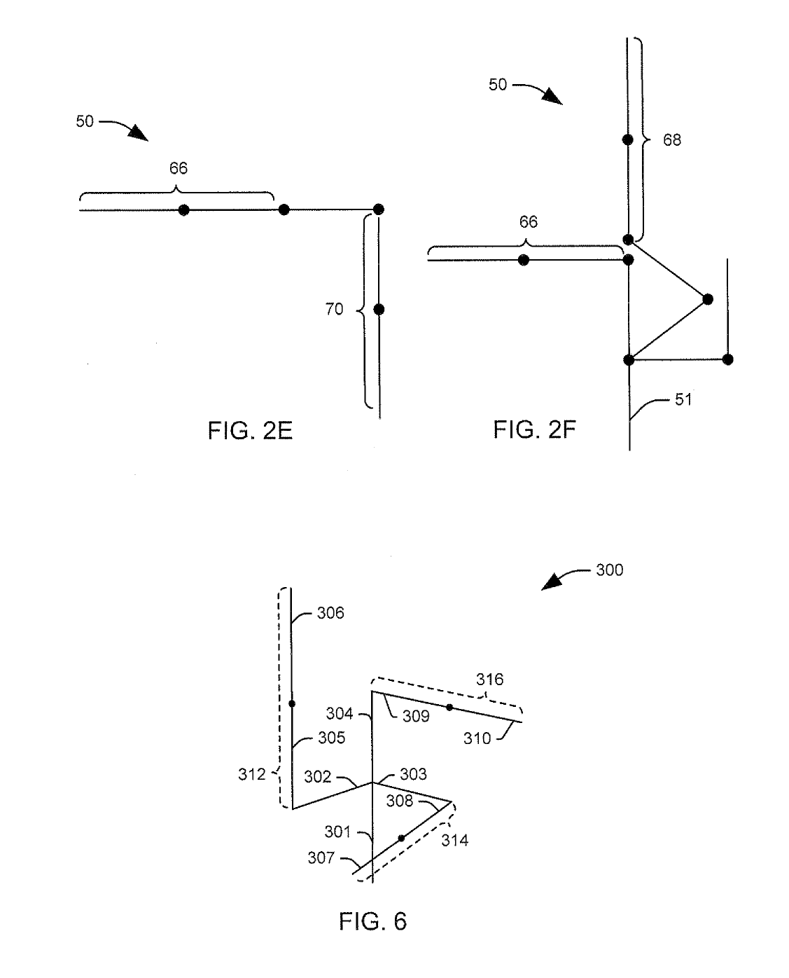

FIG. 2A illustrates a first exemplary implementation of an antenna module 50 in accordance with an aspect of the present invention. The antenna module 50 comprises a continuous, conductive structure configured to be receptive to circularly polarized radio frequency signals. The continuous conductive structure is shaped to comprise a plurality of linear elements 51-62, each having a length approximately equal to one-quarter of a characteristic wavelength of the antenna module 50. It will be appreciated that while these elements 51-62 are identified separately for ease in describing the shape of the antenna structure, each element can be formed from multiple, joined pieces of conductive material, a single piece of conductive material, or a portion of a piece of conductive material.

The antenna module comprises a first linear element 51, having a first end and a second end, and a second linear element 52 connected at a first end to the second end of the first linear element as to be collinear with the first linear element. A third linear element 53 is connected at a first end to a second end of the second linear element 52 as to be perpendicular to the second linear element. A fourth linear element 54 is connected at a first end to a second end of the third linear element 53 as to be collinear with the third linear element. Collectively, the third linear element 53 and the fourth linear element 54 form a first half-wave segment 66, aligned along a first axis.

A fifth linear element 55 is connected at a first end to the second end of the first linear element 51 as to form an obtuse angle with the first linear element. In the illustrated implementation, the first linear element 51 and the fifth linear element 55 form an angle of approximately one hundred thirty-five degrees. A sixth linear element 56 is connected at a first end to a second end of the fifth linear element 55 as to form an acute angle with the fifth linear element, such that a second end of the sixth linear element lies along a line defined by the first and second linear elements 51 and 52. In the illustrated implementation, the fifth linear element 55 and the sixth linear element 56 form an angle of approximately ninety degrees.

A seventh linear element 57 is connected at a first end to the second end of the sixth linear element 56 as to form an obtuse angle with the sixth linear element, such that the seventh linear element extends along the line defined by the first and second linear elements 51 and 52. In the illustrated implementation, the sixth linear element 56 and the seventh linear element 57 form an angle of approximately one hundred thirty-five degrees. An eighth linear element 58 connects at a first end to a second end of the seventh linear element 57 as to be collinear with the seventh linear element. Collectively, the seventh linear element 57 and the eighth linear element 58 form a second half-wave segment aligned along a second axis, perpendicular to the first axis. It will be appreciated that each of the first, second, third, fourth, fifth, sixth, seventh, and eighth linear elements 51-58 lie within a first plane defined by the first linear element and the first axis.

A ninth linear element 59 is connected at a first end to the second end of the first linear element 51 as to be perpendicular to the second linear element, extending within the first plane in a direction opposite to that of the third linear element 53 A tenth linear element 60 is connected at a first end to a second end of the ninth linear element 59 as to be perpendicular to the ninth linear element 59 and in the same direction as the second linear element 52. An eleventh linear element 61 connects at a first end to a second end of the tenth linear element 60, as to be orthogonal to the first plane. A twelfth linear element 62 connects at a first end to a second end of the eleventh linear element 61 as to be collinear with the eleventh linear element. Collectively, the eleventh linear element 61 and the twelfth linear element 62 form a third half-wave segment 70, aligned along a third axis, perpendicular to the first plane, and thus to each of the first and second axes.

The illustrated antenna module 50 provides substantial sensitivity to circularly polarized radiation within three orthogonal planes, allowing for substantially omni-directional polarization diversity, providing a true isotropic antenna. It will be appreciated that the illustrated antenna module 50 can be fed in a standard manner to provide a polarization diverse radiant element or be implemented as a passive antenna module, associated with an existing communications system, to improve the polarization diversity of the communications system. For example, the antenna module 50 can be positioned such that the first linear element 51 is in an appropriate orientation to inductively couple with an antenna of the communications system. To facilitate proper positioning of the antenna, the first linear element 51 can be connected to the second linear element 52 via a hinge or similar connecting element, such that the orientation of the first linear element can be altered to match the orientation of an associated antenna. In one implementation, the antenna module 50 can be tuned to a characteristic frequency of 2.4 GHz, and configured to attach to a laptop computer or a wireless router to enhance the performance of an internal antenna within the laptop or router (e.g., rubber duck antenna). FIG. 2B illustrates the antenna module 50, shown in a commercial packaging, coupled to a router 80 with a “rubber duck” system antenna 82 to enhance the polarization diversity of the router. FIG. 2C illustrates the packaged antenna module 50 coupled to a laptop 90 to improve connectivity of the laptop with an associated wireless network. It will be appreciated that the first linear element 51 has been bent relative to the remainder of the antenna module 50 to facilitate coupling with an internal antenna of the laptop 82.

FIG. 2D illustrates a first view of the antenna assembly 50 of FIG. 2A taken along a first axis of the three orthogonal axes and showing the components of the antenna assembly providing circular polarization along the first axis. In the illustrated view, the antenna assembly 50 is shown in increments of a quarter of the characteristic wavelength of the antenna. As can be seen in the illustrated view, the second half-wave segment 68 and the third half-wave segment 70 are mutually perpendicular, but both are in phase. It will be appreciated, however, that the second half-wave segment 68 is a quarter of a wavelength removed from the third half-wave segment 70, and thus a signal received or transmitted along the first axis from the second half-wave segment will be a quarter of a wave behind a signal received or transmitted from the third half-wave segment, and thus a quarter of a wavelength out of phase from the perspective of an observer along the first axis. It will thus be appreciated that the antenna assembly 50 is configured to provide substantial sensitivity to circularly polarized signals in a plane normal to the first axis,

FIG. 2E illustrates a second view of the antenna assembly of FIG. 2A taken along a second axis of the three orthogonal axes and showing the components of the antenna assembly providing circular polarization along the second axis. In the illustrated view, the antenna assembly 50 is shown in increments of a quarter of the characteristic wavelength of the antenna. In the illustrated view, a third half-wave segment 70 can be seen to be perpendicular to the first half-wave segment 66 and a quarter of a wavelength behind the first half-wave segment in phase. It will thus be appreciated that the antenna assembly 50 is configured to provide substantial sensitivity to circularly polarized signals in a plane normal to the second axis.

FIG. 2F illustrates a third view of the antenna assembly of FIG. 2A taken along a third axis of the three orthogonal axes and showing the components of the antenna assembly providing circular polarization along the third axis. In the illustrated view, the antenna assembly 50 is shown in increments of a quarter of the characteristic wavelength of the antenna. The antenna assembly 50 includes a first half-wave segment 66 and a second half-wave segment 68 that is oriented perpendicular to the first half-wave segment and a quarter of a wavelength behind the first half-wave segment in phase. It will thus be appreciated that the antenna assembly 50 is configured to provide substantial sensitivity to circularly polarized signals in a plane normal to the third axis.

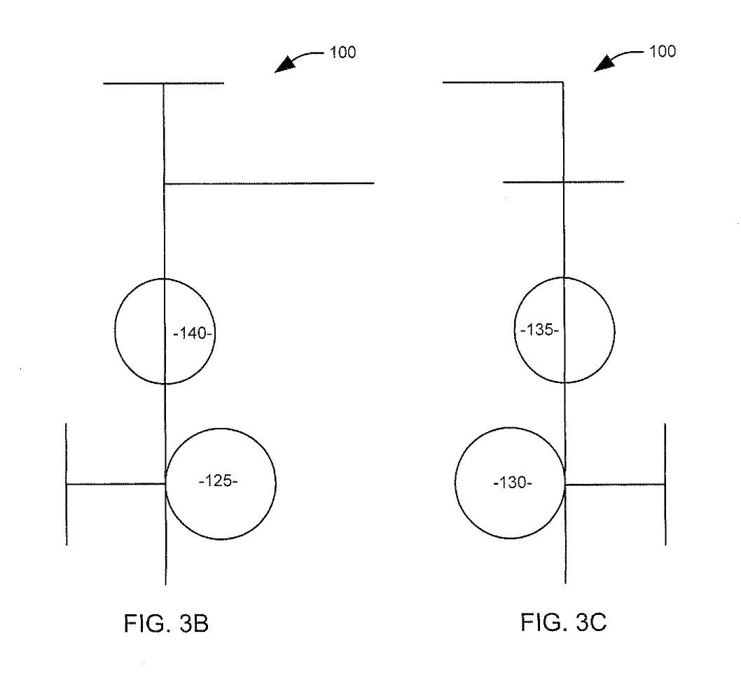

FIG. 3A illustrates a second exemplary implementation 100 of an antenna module in accordance with the present invention. The antenna module 100 comprises a continuous, conductive structure configured to be receptive to circularly polarized radio frequency signals. The continuous conductive structure is shaped to comprise a plurality of linear elements 112-119 and a plurality of curvilinear elements 121-124, 126-129, 131-134, 136-139, 141-144, and 146-149. It will be appreciated that while these elements 111-119, 121-124, 126-129, 131-134, 136-139, 141-144, and 146-149 are identified separately for ease in describing the shape of the antenna structure, each element can be formed from multiple, joined pieces of conductive material, a single piece of conductive material, or a portion of a piece of conductive material. Each of the linear elements 112-119 has a length approximately equal to one-quarter of a characteristic wavelength of the antenna module 100. Each of the curvilinear elements 121-124, 126-129, 131-134, 136-139, 141-144, and 146-149 has a length of approximately one-quarter of the characteristic wavelength, such that a circular element formed from a group of four of the curvilinear elements has a circumference approximately equal to the characteristic wavelength.

The antenna module comprises a first linear element 112, having a first end and a second end, and a second linear element 113 connected at a first end to the second end of the first linear element as to be collinear to the first linear element. Third and fourth linear elements 114 and 115 are connected at respective first ends to a second end of the second linear element 113, such that the third and fourth linear elements extend in respective directions perpendicular to the second linear element and one another. At a second end of the third linear element 114, a first group of curvilinear elements 121-124 form a first circular structure 125 oriented in a plane perpendicular to the third linear element. At a second end of the fourth linear element 115, a second group of curvilinear elements 126-129 form a second circular structure 130 oriented in a plane perpendicular to the fourth linear element and the plane of the first circular structure 125.

A fifth linear element 116 is connected at a first end to the second end of the second linear element 113 and extends in a direction collinear with the second linear element. At the second end of the fifth linear element, third and fourth groups of curvilinear elements 131-134 and 136-139 form respective third and fourth circular structures 135 and 140. The third circular structure 135 is oriented in a plane parallel to that of the second circular structure 130 and the fourth circular structure 140 is oriented in a plane parallel to that of the first circular structure 125. The first and second circular structures 135 and 140 are positioned in orthogonal planes as to share a common center and intersect at two points separated by the full diameter of the circles. At a first of these two intersection points, the circular structures 135 and 140 are joined to the second end the fifth linear element 116, and at a second of the two intersection points, a sixth linear element 117 is joined at a first end.

The sixth linear element 117 extends from the second intersection point in a direction collinear to the fifth linear element 116. Seventh and eighth linear elements 118 and 119 are connected at respective first ends to a second end of the sixth linear element 117, such that the seventh linear element 118 extends in a direction perpendicular to the sixth linear element and the eighth linear element 119 extends in a direction collinear with the sixth linear element. At a second end of the seventh linear element 118, a fifth group of curvilinear elements 141-144 form a fifth circular structure 145 oriented in a plane perpendicular to that of each of the first and second circular structures. At a second end of the eighth linear element 119, a sixth group of curvilinear elements 146-149 form a sixth circular structure 150 oriented in a plane parallel to the plane of the fifth circular structure 145.

The illustrated antenna module 100 provides substantial sensitivity to circularly polarized radiation within each of three orthogonal planes, allowing for substantially omni-directional polarization diversity. It will be appreciated that the illustrated antenna module 100 can be fed in a standard manner to provide a polarization diverse radiant element or be implemented as a passive antenna module, associated with an existing communications system, to improve the polarization diversity of the communications system. In one implementation, the antenna module 100 can be tuned to a characteristic frequency of 2.4 GHz, and configured to attach to a laptop computer or a wireless router to enhance the performance of an internal antenna within the antenna.

FIG. 3B illustrates a first view of the antenna assembly of FIG. 3A along a first axis of the three orthogonal axes and showing the components of the antenna assembly providing circular polarization in a plane normal to the first axis. In the illustrated view, the first circular element 125, having a circumference approximately equal to a wavelength, is located in the first plane and the fourth circular element 140, which has a circumference substantially equal to that of the first circular element, begins a quarter of a wavelength along the first axis from the first circular element from 115, which is itself a quarter wavelength The two circular elements 125 and 140 form orthogonal half-wave dipoles, and the dipoles are in phase. Given their separation along the first axis, a signal received or transmitted from the fourth circular element 140 will be a quarter of a wave behind a signal received or transmitted from the first circular element 125, and thus a quarter of a wavelength out of phase from the perspective of an observer along the first axis. It will thus be appreciated that the antenna assembly 100 is configured to provide substantial sensitivity to circularly polarized signals in a plane normal to the first axis.

FIG. 3C illustrates a second view of the antenna assembly of FIG. 3A along a second axis of the three orthogonal axes and showing the components of the antenna assembly providing circular polarization in a plane normal to the second axis. In the illustrated view, the second circular element 130, which has a circumference approximately equal to a wavelength, is located in the second plane and a fourth circular element 135, which has a circumference substantially equal to that of the third circular element, is located a quarter of a wavelength along the second axis from the third circular element. Each circular element 130 and 135 forms at least one half-wave dipole across its diameter, and the dipoles are in phase. Given their separation along the second axis, a signal received or transmitted from the fourth circular element 140 will be a quarter of a wave behind a signal received or transmitted from the second circular element 135, and thus a quarter of a wavelength out of phase from the perspective of an observer along the second axis. it will thus be appreciated that the antenna assembly 100 is configured to provide substantial sensitivity to circularly polarized signals in a plane normal to the second axis.

FIG. 3D illustrates a third view of the antenna assembly of FIG. 3A along a third axis of the three orthogonal axes and showing the components of the antenna assembly providing circular polarization in a plane normal to the third axis. I In the illustrated view, a fifth circular element 145, having a circumference approximately equal to a wavelength, is located in the third plane and a sixth circular element 150, having a circumference substantially equal to that of the fifth circular element, is located a quarter of a wavelength along the third axis from the fifth circular element. Each circular element 145 and 150 forms at least one half-wave dipole across its diameter, and the dipoles are in phase. Given their separation along the third axis, a signal received or transmitted from the fifth circular element 145 will be a quarter of a wave behind a signal received or transmitted from the sixth circular element 150, and thus a quarter of a wavelength out of phase from the perspective of an observer along the third axis. It will thus be appreciated that the antenna assembly 100 is configured to provide substantial sensitivity to circularly polarized signals in a plane normal to the third axis.

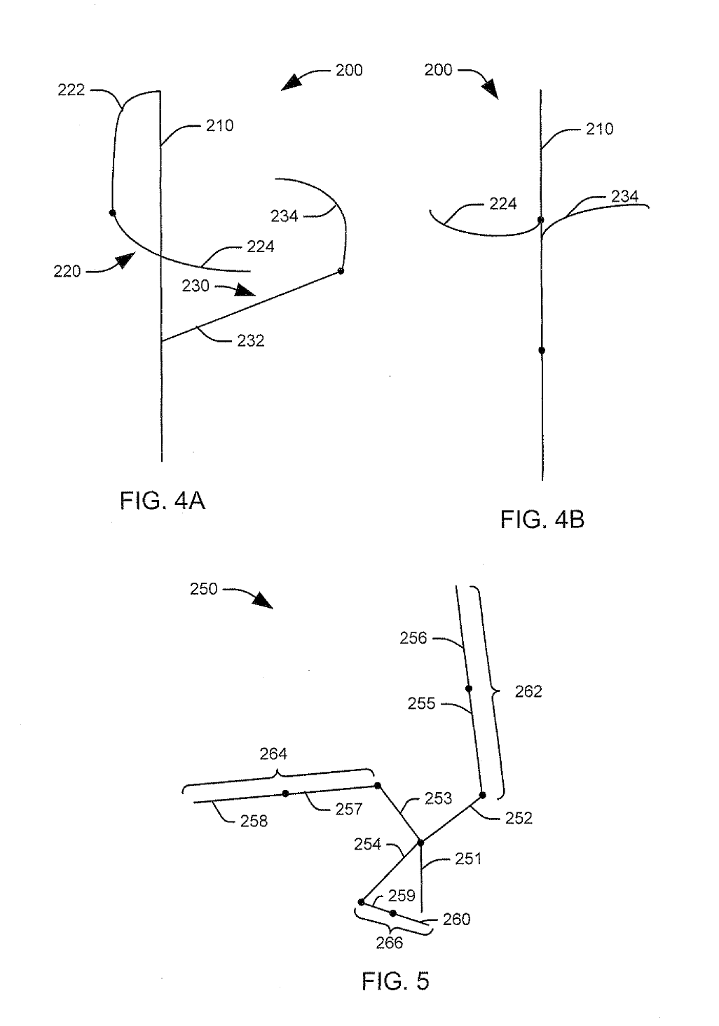

FIG. 4A illustrates a third exemplary implementation of an antenna module 200 in accordance with an aspect of the present invention. The antenna module 200 comprises a continuous, conductive structure configured to be receptive to circularly polarized radio frequency signals. The continuous conductive structure is shaped to comprise a linear base 210, with a length approximately equal to three-quarters of a characteristic wavelength of the antenna module 200, and two curvilinear arms 220 and 230, each having a length approximately equal to one-half of the characteristic wavelength. The points of intersection of the two curvilinear arms 220 and 230 with the linear base 230 can be separated by a distance approximately equal to one-half of the characteristic wavelength along the linear base. It will be appreciated that while these elements 210, 220, and 230 are identified separately for ease in describing the shape of the antenna structure, each element can be formed from multiple, joined pieces of conductive material, a single piece of conductive material, or a portion of a piece of conductive material. FIG. 4B provides an alternative view of the antenna module view along an axis defined by the linear base 210.

A first curvilinear arm 220 is connected at a first end to a first end of the linear base 210. A first portion 222 of the first curvilinear arm 220 extends outwardly from the linear base, and then curves to run roughly parallel with the linear base for approximately one-quarter of the characteristic wavelength. Collectively, the linear base and the first portion of the first curvilinear arm define a first plane. A second portion 224 of the first curvilinear arm 220 extends in a direction roughly normal to the first plane on a first side of the first plane. The second portion 224 of the first curvilinear arm 220 is slightly curved, such that a normal distance between a second end of the first curvilinear arm and the first plane is slightly less than one-quarter of the characteristic wavelength.

A second curvilinear arm 230 is connected at a first end to a point on the linear base 210 that is approximately one-half of the characteristic wavelength from the first end and one-quarter of the characteristic wavelength from a second end of the linear base. A first portion 232 of the second curvilinear arm 230 extends roughly linearly from the linear base 210 within the first plane, such that the first portion forms an angle of approximately one-hundred thirty-five degrees with a segment of the linear base bounded by its second end and the intersection with the second curvilinear arm. A second portion 234 of the second curvilinear arm 230 curves away from the first portion 232 to assume a direction roughly normal to the first plane on a second side of the first plane. The second portion 234 of the second curvilinear arm 230 is curved, such that a normal distance between a second end of the first curvilinear arm and the first plane is slightly less than one-quarter of the characteristic wavelength. Each of the first and second curvilinear arms 220 and 230 are shaped such that their respective second ends define a line roughly perpendicular to the first plane that intersects the first plane at a point having a normal distance from the linear base 220 of approximately one-quarter of a wavelength.

As will be appreciated from the illustration, the respective second ends of the first and second curvilinear arms 220 and 230 form a first dipole along a first axis perpendicular to the first plane. The linear base 210, specifically the portion of the base between its first end and the intersection of the linear base with the second curvilinear arm 230, forms a second dipole along a second axis, perpendicular to the first axis. The first and second dipoles are roughly in phase, but the two dipoles are separated by approximately one-quarter of the characteristic wavelength along a third axis, perpendicular to each of the first and second axes. The first and second dipoles collectively provide an elliptical response in a plane normal to the third axis.

A third dipole, aligned along the third axis, is formed between the respective mid-points of the first and second curvilinear arms 220 and 230, denoted as the intersections between the respective first 222 and 232 and second 224 and 234 portions of each curvilinear arm. It will be appreciated that these mid-points lie within the first plane and are on opposite sides of the linear base 210, such that the third dipole formed by these two points, slightly less than one half-wave apart, intersects the linear base. The first and third dipoles are out of phase but in approximately the same plane resulting in elliptical polarization in a plane normal to the second axis. Similarly, the second and third dipoles are out of phase but in the same plane such that the second and third dipoles collectively provide an elliptical response in a plane normal to the first axis.

FIG. 5 illustrates a fourth exemplary implementation of an antenna module 250 in accordance with an aspect of the present invention. The antenna module 250 comprises a continuous, conductive structure configured to be receptive to circularly polarized radio frequency signals. The continuous conductive structure is shaped to comprise a plurality of linear elements 251-260, each having a length approximately equal to one-quarter of a characteristic wavelength of the antenna module 250. It will be appreciated that while these elements 251-260 are identified separately for ease in describing the shape of the antenna structure, each element can be formed from multiple, joined pieces of conductive material, a single piece of conductive material, or a portion of a piece of conductive material.

The antenna module 250 comprises a first linear element 251, having a first end and a second end, and second, third, and fourth linear elements 252-254 connected at respective first ends to the second end of the first linear element. The second linear element 252 extends perpendicular to a first axis defined as parallel to the first linear element, in a first plane, defined as a plane containing the second end of the first linear element to which the first linear segment defines a normal vector.

A fifth linear element 255 is connected at a first end to a second end of the second linear element 252 and extends perpendicularly from the second linear element as to be parallel with the first axis. A sixth linear element 256 is connected at a first end to the second end of the fifth linear element 255 as to be collinear with the fifth linear element. In the illustrated implementation, the fifth linear element 255 and the sixth linear element 256 form a first half-wave linear segment 262 that is substantially parallel to the first linear element. It will be appreciated that the first linear element 251 and the first half-wave linear segment 262 extend in opposite directions from the defined first plane.

The third linear element 253 extends at an angle of one hundred thirty-five degrees from the first linear element 251 on an opposite side of the defined first plane from the first linear element, such that a projection of the third linear element onto the defined first plane would form an angle of one-hundred thirty-five degrees with the second linear element.

A seventh linear element 257 is connected at a first end to the second end of the third linear element 253 and extends perpendicularly from the third linear element. An eighth linear element 258 is connected at a first end to the second end of the seventh linear element 257 as to be collinear with the seventh linear element. In the illustrated implementation, the seventh linear element 257 and the eighth linear element 258 form a second half-wave linear segment 264 that is substantially perpendicular to the first half-wave linear segment 262.

The fourth linear element 254 extends at an angle of forty-five degrees from the first linear segment on the same side of the defined first plane, such that a projection of the fourth linear element onto the defined first plane would form an angle of one-hundred thirty-five degrees with the third linear element 253 and be roughly perpendicular to the second linear element 252. A ninth linear element 259 is connected at a first end to the second end of the fourth linear element 252 and extends perpendicularly from the fourth linear element. A tenth linear element 260 is connected at a first end to the second end of the ninth linear element 259 as to be collinear with the tenth linear element. In the illustrated implementation, the ninth linear element 259 and the tenth linear element 260 form a third half-wave linear segment 266 that is substantially perpendicular to each of the first half-wave linear segment 262 and the second half-wave segment 264.

As will be appreciated from the illustration, each of the first, second, and third half-wave linear segments 262, 264, and 266 are configured as to be in phase. The antenna module, including the angles between the first linear element 251 and each of the third and fourth linear segments 253 and 254, the angle between the fourth linear element 254 and the ninth linear element 259, and the angle between the third linear element 253 and the seventh linear element 257, is configured such that, along the first axis, defined to be parallel to the first linear segment 251, the first and second half-wave linear segments are separated by a distance slightly greater than one-quarter of a wavelength (e.g., around seven-twentieths of the characteristic wavelength) . Accordingly, the second and third half-wave linear segments 264 and 266 provide a substantially circularly polarized response in a plane normal to the first axis.

Similarly, the antenna module, including the angles between the first linear element 251 and each of the second and fourth linear segments 252 and 254, the angle between the second linear element 252 and the fifth linear element 255, and the angle between the fourth linear element 254 and the ninth linear element 259, is configured such that, along a second axis perpendicular to the first axis and parallel to the second half-wave segment 264, the first and third half-wave linear segments are separated by a distance slightly greater than one-quarter of a wavelength (e.g., around seven-twentieths of the characteristic wavelength) along a third axis perpendicular to each of the first and second axes and parallel to the third half-wave segment 266, the antenna module, including the angles between the first linear element 251 and each of the second and third linear segments 252 and 253, the angle between the third linear element 253 and the seventh linear element 255, and the angle between the second linear element 252 and the fifth linear element 255, is configured such that, the first and second half-wave linear segments 262 and 264 are separated by a distance slightly greater than one-quarter of a wavelength (e.g., around seven-twentieths of the characteristic wavelength). It will thus be appreciated that the first and third half-wave linear segments 262 and 266 provide a substantially circularly polarized response in a plane normal to the second axis, and the first and second half-wave linear segments 262 and 264 provide a substantially circularly polarized response in a plane normal to the third axis. Accordingly, the illustrated antenna module 250 is configured to provide a substantially circularly polarized response in each of three mutually perpendicular planes.

It will be appreciated that, as half-wave dipoles, the sensitivity of each half-wave linear segment 262, 264, and 266 decreases with the angle of elevation, but each of the first, second, and third have-wave linear segments 262, 264, and 266 are orthogonal and configured such that the signals have the same handedness effectively reinforce one another due to being of same handed circular polarization thusly provide continuous sensitivity at all azimuth and elevation angles by addition rather than subtraction of fields. Accordingly, the illustrated antenna system 250 provides a substantially spherical and circularly polarized response.

FIG. 6 illustrates a fifth exemplary implementation of an antenna module 300 in accordance with an aspect of the present invention. The antenna module 300 comprises a continuous, conductive structure configured to be receptive to circularly polarized radio frequency signals. The continuous conductive structure is shaped to comprise a plurality of linear elements 301-310, each having a length approximately equal to one-quarter of a characteristic wavelength of the antenna module 300. It will be appreciated that while these elements 301-310 are identified separately for ease in describing the shape of the antenna structure, each element can be formed from multiple, joined pieces of conductive material, a single piece of conductive material, or a portion of a piece of conductive material.

The antenna module 300 comprises a first linear element 301, having a first end and a second end, and second, third, and fourth linear elements 302-304 connected at respective first ends to the second end of the first linear element. The second linear element 302 extends perpendicular to a first axis defined as parallel to the first linear element, in a first plane, defined as a plane containing the second end of the first linear element to which the first linear segment defines a normal vector.

A fifth linear element 305 is connected at a first end to a second end of the second linear element 302 and extends perpendicularly from the second linear element as to be parallel with the first axis. A sixth linear element 306 is connected at a first end to the second end of the fifth linear element 305 as to be collinear with the fifth linear element. In the illustrated implementation, the fifth linear element 305 and the sixth linear element 306 form a first half-wave linear segment 312 that is substantially parallel to the first linear element 301. It will be appreciated that the first linear element 301 and the first half-wave linear segment 312 extend in opposite directions from the defined first plane.

The third linear element 303 extends from the second end of the first linear element 301 within the first plane as to be mutually perpendicular to each of the first linear element and the second linear element 302. A seventh linear element 307 is connected at a first end to the second end of the third linear element 303 and extends perpendicularly from the third linear element in a direction substantially parallel to the second linear element 302, such that the second linear element and the seventh linear element extend on the same side of the third linear element within the first plane. An eighth linear element 308 is connected at a first end to the second end of the seventh linear element 307 as to be collinear with the seventh linear element. In the illustrated implementation, the seventh linear element 307 and the eighth linear element 308 form a second half-wave linear segment 314 that is substantially perpendicular to the first half-wave linear segment 312.

The fourth linear element 304 extends collinearly with the first linear segment 301 on an opposite side of the defined first plane as to be perpendicular to each of the third linear element 303 and the second linear element 302. A ninth linear element 309 is connected at a first end to the second end of the fourth linear element 302 and extends perpendicularly from the fourth linear element in a direction substantially parallel to that of the third linear element 303. A tenth linear element 310 is connected at a first end to the second end of the ninth linear element 309 as to be collinear with the tenth linear element. In the illustrated implementation, the ninth linear element 309 and the tenth linear element 310 form a third half-wave linear segment 316 that is substantially perpendicular to each of the first half-wave linear segment 312 and the second half-wave segment 314.

As will be appreciated from the illustration, each of the first, second, and third half-wave linear segments 312, 314, and 316 are configured as to be in phase. The antenna module is configured such that, along the first axis, defined to be parallel to the first linear segment 312, the second and third half-wave linear segments 314 and 316 are separated by a distance substantially equal to one-quarter of the characteristic wavelength. Accordingly, the second and third half-wave linear segments 314 and 316 provide a substantially circularly polarized response in a plane normal to the first axis.

Similarly, the antenna module is configured such that, along a second axis perpendicular to the first axis and parallel to the second half-wave segment 314, the first and third half-wave linear segments 312 and 316 are separated by a distance substantially equal to one-quarter of the characteristic wavelength. Along a third axis perpendicular to each of the first and second axes and parallel to the third half-wave segment 316, the antenna module is configured such that, the first and second half-wave linear segments 312 and 314 are separated by a distance substantially equal to one-quarter of the characteristic wavelength. It will thus be appreciated that the first and third half-wave linear segments 312 and 316 provide a substantially circularly polarized response in a plane normal to the second axis, and the first and second half-wave linear segments 312 and 314 provide a substantially circularly polarized response in a plane normal to the third axis. Accordingly, the illustrated antenna module 300 is configured to provide a substantially circularly polarized response within each of three mutually perpendicular planes.

It will be appreciated that, as half-wave dipoles, the sensitivity of each half-wave linear segment 312, 314, and 316 decreases with the angle of elevation, but each of the first, second, and third have-wave linear segments 312, 314, and 316 are orthogonal and configured such that the signals effectively reinforce one another due to being of same handed circular polarization thusly providing continuous sensitivity at all azimuth and elevation angles by addition, rather than subtraction, of fields. Accordingly, the illustrated antenna system 300 provides a substantially spherical and circularly polarized response.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Having described the invention, I claim:

1. An antenna assembly, having a characteristic wavelength, comprising a continuous conductive assembly formed from a plurality of conductive segments, each of the plurality of conductive segments being one of linear and curvilinear and the continuous conductive assembly being configured to be substantially responsive to elliptically polarized, radio frequency signals of the characteristic wavelength within each of three mutually orthogonal planes.

2. The antenna assembly of claim 1, the plurality of conductive segments comprising a plurality of linear conductive segments, with a first linear conductive segment of the plurality of linear conductive segments aligned with a first axis normal to a first plane of the three mutually orthogonal planes, and the remainder of the plurality of linear conductive segments aligned in the first plane.

3. The antenna assembly of claim 2, the plurality of conductive segments comprising a second linear conductive segment, aligned with a second axis normal to a second plane of the three mutually orthogonal planes, each of the first and second linear conductive segment having a length substantially equal to one-half of the characteristic wavelength and the first linear conductive segment being in phase with the second linear conductive element.

4. The antenna assembly of claim 3, the plurality of conductive segments comprising a third linear conductive segment, aligned with a third axis normal to a third plane of the three mutually orthogonal planes and having a length substantially equal to one-half of the characteristic wavelength, the first linear conductive segment being ninety degrees out of phase with the second linear conductive element.

5. The antenna assembly of claim 1, the plurality of conductive segments comprising a linear base, aligned along a first axis normal to a first plane of the three mutually orthogonal axes, a first curvilinear arm connected to the linear base at a first point on the linear base, and a second curvilinear arm connected to the linear base at a second point on the linear base.

6. The antenna assembly of claim 5, the linear base having an associated length substantially equal to three-quarters of the characteristic wavelength, the first curvilinear arm being connected to the linear base at a first end of the linear base and the second curvilinear arm being connected to the linear base at a point substantially equal to one-half of the characteristic wavelength from the second end.

7. The antenna assembly of claim 5, the first and second curvilinear arms being configured such that respective first ends of the first and second curvilinear arms define endpoints of a first line, separated by between three-eights and one-half of characteristic wavelength, aligned along a second axis normal to a second plane of the three mutually orthogonal planes, and respective second ends of the first and second curvilinear arms define endpoints of a second line, separated by between three-eights and one-half of characteristic wavelength, aligned along a third axis normal to a third plane of the three mutually orthogonal planes.

8. The antenna assembly of claim 1, the plurality of conductive segments comprising a first set of curvilinear conductive segments configured to form a first circular element, a second set of curvilinear conductive segments configured to form a second circular element, a third set of curvilinear conductive segments configured to form a third circular element, a fourth set of curvilinear conductive segments configured to form a fourth circular element, a fifth set of curvilinear conductive segments configured to form a fifth circular element, a sixth set of curvilinear conductive segments configured to form a sixth circular element.

9. The antenna assembly of claim 8, the first and second circular elements being separated along a first axis normal to a first plane of the three mutually orthogonal planes by a distance substantially equal to one-quarter of a wavelength, the third and fourth circular elements being separated along a second axis normal to a second plane of the three mutually orthogonal planes by a distance substantially equal to one-quarter of a wavelength, and the fifth and sixth circular elements being separated along a third axis normal to a third plane of the three mutually orthogonal planes by a distance substantially equal to one-quarter of a wavelength.

10. The antenna assembly of claim 1, the plurality of conductive segments comprising a first, second, and third linear segments each connected at respective first ends and having a length substantially equal to one-quarter of the characteristic of a wavelength, a fourth linear segment connected to a second end of the first linear segment and aligned with a first axis normal to a first plane of the three mutually orthogonal planes, a fifth linear segment connected to a second end of the second linear segment and aligned with a second axis normal to a second plane of the three mutually orthogonal planes, a sixth linear segment connected to a second end of the third linear segment and aligned with a third axis normal to a third plane of the three mutually orthogonal planes, each of the fourth, fifth, and sixth linear segments having an associated length substantially equal to one-half of the characteristic wavelength.

11. The antenna assembly of claim 10, each of the first, second, and third linear segments being arranged such that a projection of a first linear element onto the defined first plane would form an angle of one-hundred thirty-five degrees with corresponding projections of each of the second linear element and the third linear element.

12. The antenna assembly of claim 10, each of the first, second, and third linear segments being mutually perpendicular.

13. A passive antenna module configured to enhance the performance of an associated antenna system, comprising:
a first proper subset of a plurality of conductive elements, each of the plurality of conductive elements comprising one of a linear and a curvilinear element, configured to provide a first dipole, having a length substantially equal to one-half of a characteristic wavelength associated with the antenna system, aligned along a first axis;
a second proper subset of the plurality of conductive elements configured to provide a second dipole, having a length substantially equal to one-half of the characteristic wavelength, aligned along a second axis;
a third proper subset of the plurality of conductive elements configured to provide a third dipole, having a length substantially equal to one-half of the characteristic wavelength, aligned along a third axis, the first, second, and third axes being mutually orthogonal; and
a base conductive segment configured to couple with the antenna system, each of the plurality of conductive elements being operatively connected to the base conductive segment.

14. The passive antenna module of claim 13, wherein the first proper subset, the second subset, and the third subset are not mutually exclusive subsets of the plurality of conductive elements, such that at least one of the plurality of conductive elements is part of at least two of the first proper subset, the second proper subset, and the third proper subset.

15. The passive antenna module of claim 13, wherein the first proper subset of a plurality of conductive elements are configured such that the first dipole is formed across an open space between an endpoint of a first conductive segment and an endpoint of a second conductive segment.

16. The passive antenna module of claim 13, further comprising a fourth proper subset of the plurality of conductive elements being configured to provide a difference in phase between the first dipole and the second dipole.

17. A communications system configured to provide polarization diversity comprising:
means for receiving elliptically polarized, radio frequency signals within each of three mutually orthogonal planes, the means for receiving comprising a continuous, conductive member; and
a transceiver system, electrically coupled to the means for receiving, configured to receive a radio frequency signal from the means for receiving and process the radio frequency signal to recover information from the radio frequency signal.

18. The communications system of claim 17, the continuous conductive member comprising a first portion, located in a first plane of the three mutually orthogonal planes, and a second portion, extending linearly along a first axis orthogonal to the first plane for a distance substantially equal to one-quarter of a characteristic wavelength associated with the transceiver system.

19. The antenna system of claim 17, the transceiver system comprising an antenna configured to inductively couple with the means for receiving.

20. The antenna system of claim 17, the transceiver system comprising an antenna feed, the means for receiving being conductively coupled to the antenna feed.
